(19) United States
(12) Patent Application Publication
(10) Pub. No.: US 2013/0285945 A1
(43) Pub. Date: Oct. 31, 2013

(54) TOUCH SENSING PANEL AND TOUCH SENSING DEVICE FOR DETECTING MULTI-TOUCH SIGNAL

(71) Applicants: Do Hwan Oh, Seoul (KR); Dong Jin Min, Gyeonggi-do (KR); Dong Yoon Han, Gyeongsangbuk-do (KR)

(72) Inventors: Do Hwan Oh, Seoul (KR); Dong Jin Min, Gyeonggi-do (KR); Dong Yoon Han, Gyeongsangbuk-do (KR)

(73) Assignee: MELEFAS, INC., Seoul (KR)

(21) Appl. No.: 13/808,647

(22) PCT Filed: Feb. 24, 2011
(86) PCT No.: PCT/KR2011/001286

§ 371 Date: Jan. 7, 2013

(30) Foreign Application Priority Data
Jul. 8, 2010 (KR) 10-2010-0065868

(51) Int. Cl. G06F 3/044

(52) U.S. Cl. CPC G06F 3/044
USPC 345/173; 200/600

(57) ABSTRACT

Provided are a touch sensing panel and a touch sensing panel for detecting multiple touches, including a first conductive trace formed along a first axial direction, a second conductive trace formed along a second axial direction intersecting the first axis, and an auxiliary conductive trace electrically connected to the second conductive trace, and formed along the first axial direction. An interpolation effect of a touched input moving in a horizontal direction may be expected, and an accuracy and linearity of the touched input may be enhanced through the auxiliary conductive trace generating a detected signal so that a dead region with respect to the touched input may be prevented from occurring.

### TECHNICAL FIELD

The present invention relates to a touch sensing technology for detecting a touch, and more particularly, to a touch sensing panel and a touch sensing panel for detecting an absolute location with respect to at least one touch.

### BACKGROUND ART

A touch sensing technology for detecting a touch by a finger of a user or by an apparatus, and for converting the touch to a suitable electric signal and outputting the electric signal has been applied to various electric devices to be used as various input means.

The touch sensing technology may be applied to a laptop computer to be used as a means of controlling a move of a curser replacing a mouse. The touch sensing technology may be combined with a display device to be used as an input means capable of directly selecting and executing an icon or a menu displayed on a screen.

Recently, a screen of an electronic device is being enlarged and the electronic device is being miniaturized and thus, an input device such as a keypad may be excluded, and a case of using a touch screen combined with a display as an only input means is on the rise.

The expansion of applying the touch sensing panel may involve a change of an input scheme, and one example may correspond to a scheme of detecting at least two touched inputs.

An existing touch sensing panel has been detecting a single touched input, and an input type has been limited.

For example, in the touch sensing technology replacing a mouse, even though a location of a curser is controlled by a touched input, an input corresponding to a click has been performed by an additional button. However, a recent touch sensing technology may recognize at least two touched inputs without an additional button.

To recognize at least two touched inputs, relative motions of the at least two touched inputs may be detected, or absolute coordinates of the at least two touched inputs may be independently detected.

Even though a function of detecting relative motions may be implemented by various Indium Tin Oxide (ITO) electrode patterns such as a 1-layer pattern, a 2-layer pattern, diamond pattern, and the like, a ghost phenomenon where an absolute coordinate of a plurality of touched inputs may not be calculated may occur.

Recently, to overcome the ghost phenomenon, a number of manufacturers tend to apply a drive-sensing principle where absolute coordinates of a plurality of touched inputs are calculated.

### DISCLOSURE OF INVENTION

### Technical Problem

According to an aspect of the present invention, by enhancing a sensitivity of a mutual capacitance detected based on a drive-sensing principle, a touch sensitivity may subsequently be enhanced.

According to an aspect of the present invention, by disposing an auxiliary conductive trace in a branch form that is extending in a horizontal direction in a portion where a conductive trace for a sensing that is extending in a longitudinal direction is formed, an interpolation effect of a touched input moving in a horizontal direction may be expected.

According to an aspect of the present invention, an accuracy and linearity of a touched input may be enhanced through an auxiliary conductive trace generating a detected signal so that a dead region with respect to a touched input may be prevented from occurring

According to an aspect of the present invention, by disposing an auxiliary conductive trace between conductive traces for a driving, a resolution of a touch sensing panel may be enhanced.

### Solution to Problem

According to an aspect of the present invention, there is provided a touch sensing panel, including a plurality of first conductive traces formed along a first axial direction, a plurality of second conductive traces formed along a second axial direction intersecting the first axis, and a plurality of auxiliary conductive traces electrically connected to the plurality of second conductive traces, and formed along the first axial direction.

According to an aspect of the present invention, there is provided a touch sensing apparatus including a plurality of sensing regions defined by at least one first electrode and at least one second electrode, a touch sensor chip to generate touch information based on a change of a mutual capacitance generated from at least one sensing region among the plurality of sensing regions, and a wiring pattern to electrically connect the plurality of sensing regions to the touch sensor chip, wherein the at least one second electrode is electrically connected to an auxiliary electrode formed between the at least one first electrode, and the auxiliary electrode extends in a length direction of the at least one first electrode.

### BRIEF DESCRIPTION OF DRAWINGS

FIG. 1 is a diagram illustrating an example of an electronic device using a touch sensing panel according to an embodiment of the present invention.

FIG. 2 is a block diagram illustrating an internal configuration of a touch sensor chip according to an embodiment of the present invention.

FIG. 3 is a diagram illustrating conductive traces of a touch sensing panel according to an embodiment of the present invention.

FIG. 4 is a diagram illustrating a conductive trace for a sensing among conductive traces according to an embodiment of the present invention.

FIG. 5 is a diagram illustrating a conductive trace for applying a driving signal among conductive traces according to an embodiment of the present invention.

FIG. 6 is a diagram further illustrating a configuration of a first conductive trace, a second conductive trace, and an auxiliary conductive trace according to an embodiment of the present invention.

FIG. 7 is a diagram further illustrating a configuration of a first conductive trace, a second conductive trace, and an auxiliary conductive trace formed on a touch panel according to another embodiment of the present invention.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

An electrode and a conductive trace used in this specification may be regarded as sharing a similar meaning.

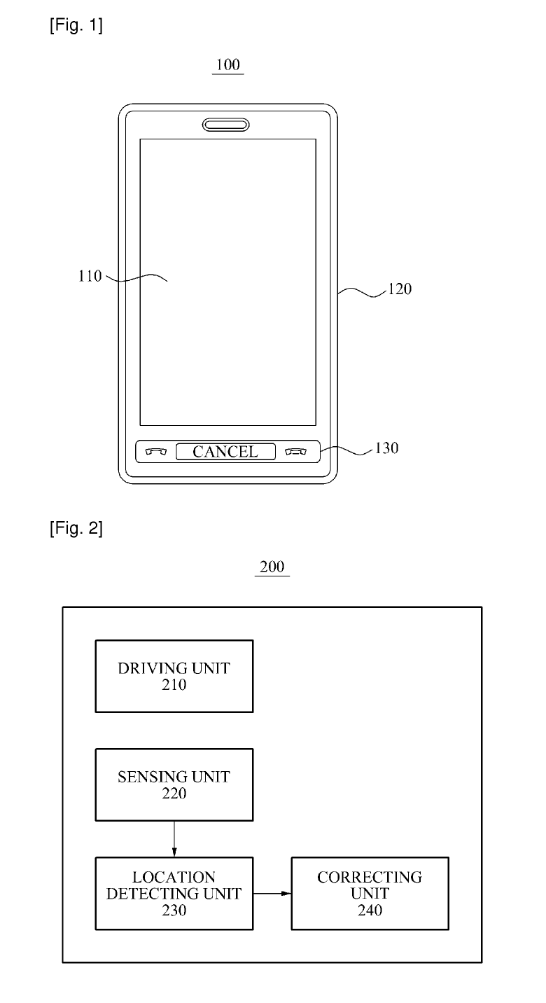

FIG. 1 is a diagram illustrating an example of an electronic device 100 using a touch sensing panel according to an embodiment of the present invention.

The electronic device 100 described in this specification may correspond to electronic equipment such as a television, a digital versatile disc (DVD) player, a refrigerator, a laptop computer, a washing machine, a desktop computer, a liquid crystal display, and the like in addition to a portable electronic device such as a mobile telecommunication terminal, a portable media player (PMP), a personal digital assistant (PDA), a global positioning system (GPS), an MPEG Audio Layer-3 (MP3) player, a portable game machine, a laptop computer, and the like.

The electronic device 100 according to an embodiment of the present invention may include at least one of a display 110 disposed at a location where the touch sensing panel is formed, a housing 120 approximating an appearance of the electronic device 100, an input key 130 provided separately from the touch sensing panel.

The input key 130 may include a frequently used key for operating the electronic device 100 separate from the touch sensing panel, and may be regarded as a mechanical input key or a touch key having a touch sensor, and the like.

According to an embodiment, the input key 130 may be removed to process all inputs thorough the touch sensing panel.

The display 110 may correspond to a module for outputting an image associated with a motion to a user, and may be implemented by a liquid crystal display, a plasma display panel, an organic light emitting device, and the like.

The touch sensing panel may be attached to the display 110 to receive a touched input through a body of the user, a stylus pen, and the like.

The touch sensing panel according to an embodiment may be attached to the display 110 to determine an input in response to a touch. The touch sensing panel may include a substrate and a conductive trace disposed on the substrate.

The conductive trace included in the touch sensing panel according to an embodiment may include a first conductive trace for sensing a touch, and a second conductive trace receiving a driving signal to form a mutual capacitance between the first conductive trace and the second conductive trace.

The touch sensing panel according to an embodiment may further include an auxiliary conductive trace capable of enhancing a change of a mutual capacitance occurring in response to a connection to the second conductive trace disposed between the auxiliary conductive trace and the second conductive trace connected to the auxiliary conductive trace.

A transparent window may be attached to the conductive trace to receive a touch from a user. The transparent window may be configured by a material resistant to a scratch and a shock such as a strengthened glass, an acryl, and the like.

In response to a touch applied to the transparent window, a change of a mutual capacitance may occur, and the change may be detected by the touch sensor chip.

The touch sensor chip may be mounted on a flexible printed circuit board (FPCB), or may be mounted on the substrate of the touch sensing panel in a chip-on-glass (COG) form to be electrically connected to at least one of the first conductive trace and the second conductive trace.

The touch sensor chip according to an embodiment may detect a change of a mutual capacitance generated by a touched object and between the first conductive trace and the second conductive trace, and may generate touch information based on the change of a mutual capacitance.

FIG. 2 is a block diagram illustrating an internal configuration of a touch sensor chip 200 according to an embodiment of the present invention.

Referring to FIG. 2, the touch sensor chip 200 according to an embodiment of the present invention may include a driving unit 210 to apply a driving signal to a conductive trace for a driving, a sensing unit 220 to receive a detected signal from a conductive trace that is selected by the driving signal and to generate touch information based on the received detected signal, and a location detecting unit 230 to detect a location corresponding to a occurring touch based on the generated touch information.

The sensing unit 220 may detect whether a touch occurs or a number of touches occur, based on the received detected signal.

The touch sensor chip 200 according to an embodiment of the present invention may further include a correcting unit 240 to correct the detected location.

The location detecting unit 230 may calculate a touch coordinate on a touch sensing panel, and an error of the calculated touch coordinate may be corrected through the correcting unit 240.

The correcting unit 240 may correct a touched location using a value recorded in a predetermined table.

An error may occur during a determination of the touched location due to an electrical resistance. By recording a value capable of correcting a resistance component in advance in the predetermined table, and by calculating the touched location using a value recorded in the predetermined table as necessary, an error occurring while calculating a touched location may be corrected.

As another example, the correcting unit 240 may enhance an accuracy of determining a touched location by maintaining, in the predetermined table, a value for correcting a coordinate instead of the resistance component, and by correcting the coordinate using the value recorded in the table.

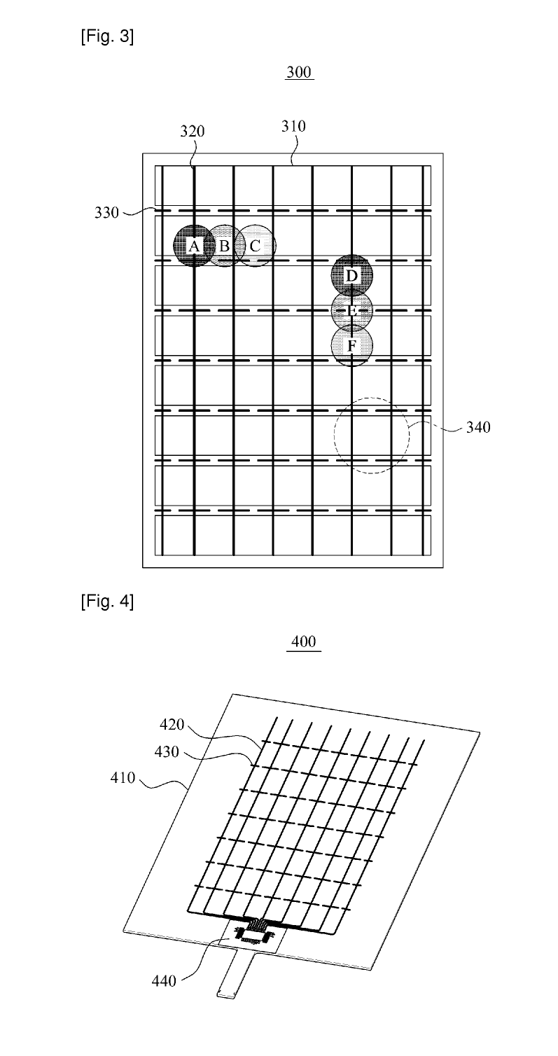

FIG. 3 is a diagram further illustrating a touch sensing panel 300 according to an embodiment of the present invention.

The touch sensing panel 300 according to an embodiment of the present invention may include a plurality of first conductive traces 310, a plurality of second conductive traces 320, and a plurality of auxiliary conductive traces 330.

The plurality of first conductive traces 310 may be formed along a first axial direction, the plurality of second conductive traces 320 may be formed along a second axial direction intersecting the first axis, and the plurality of auxiliary conductive traces 330 may be electrically connected to the plurality of second conductive traces, and may be formed along the first axial direction.

Note that, the first axial direction may be regarded as being orthogonal to the second axial direction.

Referring to FIG. 3, the plurality of first conductive traces 310 may be formed along a horizontal direction, that is, the first axial direction, and the plurality of second conductive traces 320 may be formed along a longitudinal direction, that is, the second axial direction.

In particular, the plurality of first conductive traces 310 may be isolated from each other at predetermined intervals along the second axial direction, and the plurality of auxiliary conductive traces 330 may be disposed to correspond to intervals between the plurality of first conductive traces 310.

Each of the plurality of second conductive traces 320 may be formed at locations adjacent to each other, and the plurality of auxiliary conductive traces 330 may be electrically connected to each of the plurality of second conductive traces 320 adjacent to each other, may be formed at the same location in the second axial direction, and may be adjacent to each other in the first axial direction.

The touch sensing panel may further include a touch sensor chip.

The touch sensor chip may generate touch information based on a change of a capacitance generated, by a touched object, from at least one of the plurality of first conductive traces 310, the plurality of second conductive traces 320, and the plurality of auxiliary conductive traces 330.

The plurality of first conductive traces 310 may be regarded as a driving channel for applying a driving signal, and the plurality of second conductive traces 320 and the plurality of auxiliary conductive traces 330 may be regarded as a sensing channel for detecting a change of a mutual capacitance by a touched object, based on the driving signal.

The driving signal may be generated from the touch sensor chip, and the touch sensor chip may receive the touch information detected through at least one of the plurality of second conductive traces 320 and the plurality of auxiliary conductive traces 330 based on the driving signal, and may output a selected response.

Similar to the plurality of first conductive traces 310, the plurality of auxiliary conductive traces 330 may be formed along the horizontal direction, that is, the first axial direction. The plurality of auxiliary conductive traces 330 may be formed along the horizontal direction, that is, the first axial direction, along which the plurality of first conductive traces 310 is formed.

The plurality of first conductive traces 310 may include at least one first line set formed to be isolated by a predetermined space in the horizontal direction, that is, the first axial direction.

The plurality of first conductive traces 310 may be formed by the first line set including a plurality of first lines, and each of the first lines may be formed to be isolated by a predetermined space, thereby electrically insulated from each other.

The plurality of second conductive traces 320 may include at least one second line set formed to be isolated by a predetermined space in the longitudinal direction, that is, the second axial direction.

A line used in this specification may be regarded as a conductive trace.

At least one of the plurality of first conductive traces 310, the plurality of second conductive traces 320, and the plurality of auxiliary conductive traces 330 may be regarded as an indium tin oxide (ITO) on a glass substrate.

In a case where the touch sensing panel may not be transparent and used as only a means for an input, the at least one conductive trace may be regarded as copper on a flame retardant 4 (FR4) substrate.

Similar to the plurality of first conductive traces 310, the plurality of second conductive traces 320 may be formed by the second line set including a plurality of second lines, and each of the second lines may be formed to be isolated by a predetermined space, thereby electrically insulated from each other.

The plurality of auxiliary conductive traces 330 may include at least one auxiliary line set formed along the horizontal direction, that is, the first axial direction, and the at least one auxiliary line set may include a plurality of auxiliary lines.

Each of the plurality of auxiliary lines may be electrically connected to each of the second lines. Each of the plurality of auxiliary lines electrically connected to each of the second lines may be electrically insulated from each other.

The plurality of auxiliary lines may be located in a space between two first lines different from each other.

The first lines configuring the plurality of first conductive traces 310 may be formed to be isolated by a predetermined space in the first axial direction, and each of the plurality of auxiliary lines may be formed in the space dividing the first lines.

The plurality of auxiliary lines configuring the at least one auxiliary line set may be located to be adjacent to each other in the horizontal direction, that is the first axial direction.

Accordingly, even though a touched object moves from a location A to a location B, and to a location C along the horizontal direction, that is the first axial direction orthogonal to a length direction of the plurality of second conductive traces 320 corresponding to sensing channels, an accurate and rapid touch sensing may be possible through the plurality of auxiliary conductive traces 330.

The plurality of second conductive traces 320 formed along the longitudinal direction may accurately and rapidly sense a movement of a touched object in the longitudinal direction from a location D to a location E, and to a location F.

According to an embodiment, by disposing an auxiliary conductive trace in a branch form that is extending in the horizontal direction in a portion where a conductive trace for a sensing that is extending in the longitudinal direction is formed, an interpolation effect of a touched input moving in the horizontal direction may be expected.

According to an embodiment, an accuracy and linearity of a touched input may be enhanced through the auxiliary conductive trace generating a detected signal so that a dead region with respect to a touched input may be prevented from occurring.

According to an embodiment, by disposing the plurality of auxiliary conductive traces 330 between a space formed between the first lines configuring the plurality of first conductive traces 310, a resolution of a touch sensing panel may be enhanced.

A portion of the auxiliary lines located at each end in the first axial direction among the plurality of auxiliary lines configuring the auxiliary line set may be formed to have a relatively short length in comparison with the other plurality of auxiliary lines.

The plurality of auxiliary lines located at most outer columns, that is, each end column of a substrate may have a relatively short length in the horizontal direction in comparison with the other plurality of auxiliary lines.

The touch sensing panel according to an embodiment of the present invention may be used for a touch screen apparatus having a display apparatus for displaying a user interface, and a circuit for generating a control signal controlling a host device by recognizing a touch event occurring at different locations on a touch sensitive surface.

The touch sensing panel may correspond to a part of components of the touch sensing apparatus.

The touch sensing apparatus according to an embodiment may include a plurality of sensing regions, the touch sensor chip, and the wiring patterns.

A sensing region 340 may be defined by at least one first electrode and at least one second electrode, and may be formed in a form where a plurality of sensing regions are connected to implement a touch sensing function.

All of the plurality of sensing regions according to an embodiment may be formed on the same plane.

All of the plurality of sensing regions connected to each other to form a conductive trace may be formed on the same plane.

The plurality of sensing regions may be formed in the same pattern as a pattern of the sensing region 340, and the second electrode configuring the sensing region 340 may further include at least one auxiliary electrode formed in at least one region not overlapping the first electrode in an axial direction of the first electrode.

The touch sensor chip may generate touch information based on a change of a mutual capacitance occurring in a touched region formed by the first electrode, the second electrode, and the auxiliary electrode.

The first electrode may be disposed in a space formed by a plurality of second electrodes that are adjacent to each other, and may be electrically connected to the other first electrodes included in the other neighboring sensing region in the first axial direction.

The second electrode may be electrically connected to an auxiliary electrode formed between the first electrodes, and the auxiliary electrode may extend in a length direction of the first electrode.

The touch sensor chip according to an embodiment may apply a predetermined driving signal to at least a portion of the first electrode, and may acquire a detected signal according to a touched object from the second electrode included in the same sensing region as the first electrode where the driving signal is applied, and/or from the auxiliary electrode electrically connected to the second electrode.

The touch sensor chip may acquire, as the detected signal, a change of a mutual capacitance generated between the second electrode and the first electrode where the predetermined driving signal is applied, or between the auxiliary electrode and the first electrode where the predetermined driving signal is applied, thereby detecting a touch of a touched object.

The wiring pattern may perform a function of connecting the sensing region to the touch sensor chip.

FIG. 4 is a diagram illustrating a conductive trace for a sensing formed on a touch panel 400 among conductive traces according to an embodiment of the present invention.

The touch panel 400 may include the conductive trace for a sensing on one side of a substrate 410.

A second conductive trace 420 and an auxiliary conductive trace 430 may be included on the substrate 410 to sense a touched object.

The second conductive trace 420 may be formed in a longitudinal direction and connected to a touch sensor chip 440, and the auxiliary conductive trace 430 may be formed in a horizontal direction. Each auxiliary line configuring the auxiliary conductive trace 430 may be electrically connected to each of corresponding second line among second lines configuring the second conductive trace 420.

By disposing an auxiliary electrode in a branch form that is extending in the horizontal direction in a portion where a sensing electrode extending in the longitudinal direction is formed, an interpolation effect of a touched input moving in the horizontal direction may be expected. Since the auxiliary electrode may generate a sensing signal so that a dead region may be prevented from occurring between sensing electrodes in the longitudinal direction while a touched input moves from the location A to the location B, and to the location C, a linearity of the touched input moving in the horizontal direction may increase.

A linearity in the longitudinal direction may increase due to a similar principle.

When the touched input is assumed to move from the location D to the location E, and to the location F, a linearity may increase by the auxiliary electrode disposed between each driving electrode.

A location in the longitudinal direction has been detected by the driving electrode where a signal is successively applied. However, the auxiliary electrode between driving electrodes may be additionally used, thereby enhancing both an accuracy and a linearity.

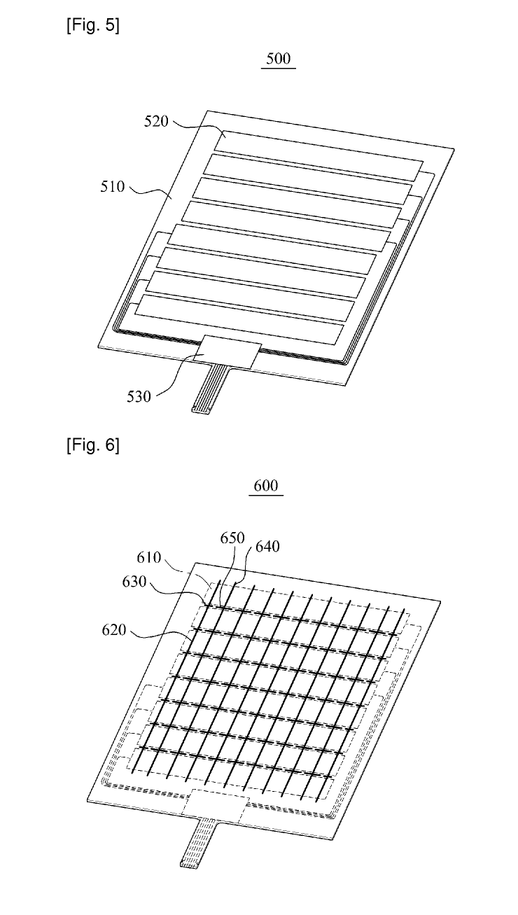

The driving electrode will be further described with reference to FIG. 5.

FIG. 5 is a diagram illustrating a conductive trace for applying a driving signal formed on a touch panel 500 among conductive traces according to an embodiment of the present invention.

The touch panel 500 may include a first conductive trace 520 for applying a driving signal to a side of a substrate 510 where a conductive trace for a sensing is not formed.

The first conductive trace 520 may be connected to a touch sensor chip for controlling an application of the driving signal.

First lines configuring the first conductive trace 520 may be formed in a form of a conductive trace extending in a horizontal direction, and may be isolated from each other by a predetermined space in a longitudinal direction.

The auxiliary lines of FIG. 4 may be formed in a predetermined space dividing each of the first lines in the longitudinal direction.

In particular, the auxiliary electrodes adjacent to different driving electrodes on the top surface and the bottom surface may generate a coupling capacitance only on a surface adjacent to the driving electrode where the driving signal is applied. Thus, a linearity of the touched input may be enhanced regardless of an interval between driving electrodes.

In a case of manufacturing a touch screen of the above-mentioned structure using an ITO glass, a phenomenon in which a pattern of the driving electrode is recognized by a user may occur.

A scheme of inserting a dummy pattern between the driving electrodes may be applied to solve a problem of the phenomenon. However, since a parasitic capacitance may increase due to the scheme, accuracy of determining a touch may deteriorate. Thus, according to an embodiment, by disposing the auxiliary electrode connected to the sensing electrode between the driving electrodes, an additional effect of solving the problem of the phenomenon in which the driving electrode is recognized may be expected.

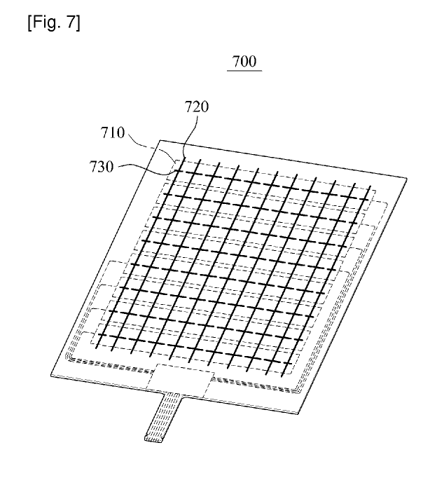

FIG. 6 is a diagram further illustrating a configuration of a first conductive trace 610, a second conductive trace 620 and 640, and an auxiliary conductive trace 630 and 650 formed on a touch panel 600 according to an embodiment of the present invention.

The first conductive trace 610, the second conductive traces 620 and 640, and the auxiliary conductive traces 630 and 650 according to an embodiment of the present invention may be disposed on a single layer.

In this instance, the first conductive trace 610 may maintain an insulated state through a connection bridge at a point intersecting the second conductive trace 620 and 640.

In particular, in a case where a touch sensing panel according to an embodiment is formed in a single layer, a point where a connection line of the first conductive trace 610 intersects the second conductive traces 620 and 640 may be formed in a connecting bridge pattern.

In this case, the first conductive trace 610 and the second conductive traces 620 and 640 may be formed on different planes, and both of a metal and an ITO may be used as a material of a conductive trace.

The first conductive trace 610, the second conductive traces 620 and 640, and the auxiliary conductive traces 630 and 650 according to an embodiment of the present invention may be disposed on different layers to be electrically isolated from each other.

An auxiliary line 630 of auxiliary conductive traces may be electrically connected to a first line 620 of second conductive traces, and an auxiliary line 650 may be connected to a second line 640.

Note that, since the auxiliary line 630 may correspond to the first line 620 formed at a left edge, the auxiliary line 630 may be formed to have a shorter length in a horizontal direction in comparison with the auxiliary line 650 corresponding to the second line 640.

The auxiliary conductive trace 630 electrically connected to the second conductive trace 620 located at an end in the first axial direction may be formed to have a shorter length in comparison with the other auxiliary conductive traces.

FIG. 7 is a diagram further illustrating a configuration of a first conductive trace 710, a second conductive trace 720, and an auxiliary conductive trace 730 formed on a touch panel 700 according to another embodiment of the present invention.

The first conductive trace 710, the second conductive trace 720, and the auxiliary conductive trace 730 may be located on different multiple layers.

In particular, the first conductive trace 710 may be formed on a first layer, and the second conductive trace 720 and the auxiliary conductive trace 730 electrically connected to each other may be formed on a second layer that is electrically insulated from the first conductive trace 710.

The auxiliary conductive trace 730 and the first conductive trace 710 may be formed at the same location and may maintain an electrically insulated state on different layers.

The auxiliary conductive trace 730 and the first conductive trace 710 may extend in a first axial direction, and the second conductive trace 720 may extend in a second axial direction intersecting the first axis.

The auxiliary conductive trace 730 placed at the same location on the second axial direction may be disposed to be adjacent to each other in the first axial direction.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A touch sensing panel, comprising:
a plurality of first conductive traces formed along a first axial direction;
a plurality of second conductive traces formed along a second axial direction intersecting the first axis; and
a plurality of auxiliary conductive traces electrically connected to the plurality of second conductive traces, and formed along the first axial direction.

2. The touch sensing panel of claim 1, wherein:
the plurality of first conductive traces are isolated from each other at predetermined intervals along the second axial direction, and the plurality of auxiliary conductive traces are disposed to correspond to intervals between the plurality of first conductive traces.

3. The touch sensing panel of claim 1, wherein the plurality of auxiliary conductive traces formed at the same location on the second axis and connected to the other second conductive traces which are adjacent and parallel to each other in the first axial direction, are adjacent to each other in the first axial direction.

4. The touch sensing panel of claim 2, wherein auxiliary conductive traces connected to second conductive traces located at each end in the first axial direction have a shorter length than other auxiliary conductive traces.

5. The touch sensing panel of claim 1, wherein the first axial direction is orthogonal to the second axial direction.

6. The touch sensing panel of claim 1, wherein the plurality of second conductive traces and the plurality of auxiliary conductive traces are placed on a single layer.

7. The touch sensing panel of claim 1, wherein the plurality of first conductive traces are formed on a different layer from a layer where the plurality of second conductive traces and the plurality of auxiliary conductive traces are formed, and are electrically isolated from the plurality of second conductive traces and the plurality of auxiliary conductive traces.

8. The touch sensing panel of claim 1, further comprising:
a touch sensor chip to generate touch information based on a change of a capacitance generated, by a touched object, from at least one of the plurality of first conductive traces, the plurality of second conductive traces, and the plurality of auxiliary conductive traces.

9. The touch sensing panel of claim 8, wherein the touch sensor chip applies a predetermined driving signal to at least a portion of the plurality of first conductive traces, and generates the touch information based on a change of a mutual capacitance generated from at least one of the plurality of second conductive traces and the plurality of auxiliary conductive traces adjacent to the plurality of first conductive traces where the predetermined driving signal is applied.

10. A controller chip to detect a touched input applied to the touch sensing panel according to claim 1.

11. A touch sensing apparatus comprising:
a plurality of sensing regions defined by at least one first electrode and at least one second electrode;
a touch sensor chip to generate touch information based on a change of a mutual capacitance generated from at least one sensing region among the plurality of sensing regions; and
a wiring pattern to electrically connect the plurality of sensing regions to the touch sensor chip, wherein
the at least one second electrode is electrically connected to an auxiliary electrode formed between the at least one first electrode, and
the auxiliary electrode extends in a length direction of the at least one first electrode.

12. The touch sensing apparatus of claim 11, wherein all of the pluralities of sensing regions are disposed on the same plane.

13. The touch sensing apparatus of claim 11, wherein the touch sensor chip applies a predetermined driving signal to the at least one first electrode, and acquires a detected signal according to a touched object from the at least one second electrode adjacent to the at least one first electrode where the predetermined driving signal is applied, and from the auxiliary electrode electrically connected to the at least one second electrode that is adjacent to the at least one first electrode.

14. The touch sensing apparatus of claim 13, wherein the touch sensor chip acquires, as the detected signal, a change of a mutual capacitance generated between the at least one second electrode and the at least one first electrode where the predetermined driving signal is applied or between the auxiliary electrode and the at least one first electrode where the predetermined driving signal is applied.

15. The touch sensing apparatus of claim 11, wherein the at least one first electrode is formed on a different layer from a layer where the at least one second electrode and the auxiliary electrode are formed, and is electrically isolated from the at least one second electrode and the auxiliary electrode.

16. The touch sensing apparatus of claim 15, wherein the at least one first electrode and the auxiliary electrode extend in a first axial direction, and the at least one second electrode extends in a second axial direction intersecting the first axis.

17. The touch sensing apparatus of claim 16, wherein auxiliary electrodes placed at the same location on the second axis are disposed to be adjacent to each other in the first axial direction.
